(19) United States
(12) Patent Application Publication
(10) Pub. No.: US 2012/0107070 A1
(43) Pub. Date: May 3, 2012

(54) SELF-DRILLING FASTENING ELEMENT

(75) Inventors: Robert Bongartz, Neuss (DE); Stephan Esper, Neuwied (DE); Stefan Ahlborn, Willich (DE)

(73) Assignee: RUIA GLOBAL FASTENERS AG, Neuss (DE)

(21) Appl. No.: 13/379,579

(22) PCT Filed: Jun. 28, 2010
(86) PCT No.: PCT/DE10/50041

§ 371 Date: Dec. 20, 2011

(30) Foreign Application Priority Data
Jul. 15, 2009 (DE) 20 2009 009 651.3

(51) Int. Cl. F16B 25/00

(52) U.S. Cl. 411/378

(57) ABSTRACT

The invention relates to a self-drilling fastening element (10), comprising a rotationally symmetrical drilling tip (16) and a shaft (14), wherein the cross-section of the drilling tip (16) is bounded by a first radius (R2), the origin (22) of which lies outside the rotational axis (18) of the drilling tip (16) on the side opposite the rotational axis (18), near the drilling tip (16), and a second radius (RI) near the shaft (14), wherein the origin (26) of the second radius (RI) is farther from the rotational axis (18) than the origin (22) of the first radius (R2) and likewise lies on the opposite side of the rotational axis (18).

### TECHNICAL FIELD

The present invention relates to a self-drilling fastening element, for example a drilling screw or a self-drilling blind rivet, comprising a rotationally symmetrical drilling tip and a shank.

Self-drilling fastening elements of this type are increasingly in demand, since the expensive pilot drilling and thread-cutting can be dispensed with.

### PRIOR ART

Originally, cutting drilling tips were frequently used in this context. However, a drawback of this is the resulting shavings which have to be removed. By contrast, in the meantime non-cutting methods have become established, in which the material in which the fastening element is to be placed is heated—by a suitably formed tip, which is pressed at a high rotational speed against the workpiece in which the fastening element is to be placed—and thus becomes plastic. The fastening element is subsequently screwed into the workpiece which has been softened in this manner. Advantageously, not only does this not produce any shavings, but in addition a tube, i.e. a material bank, is produced and can be used to increase the length of the supporting thread after the fastening element has been placed.

Corresponding fastening elements according to the prior art had conical (for example DE 10 2006 034 585), flattened and hollow (DE 10 2006 034 583), or spherical (for example 10 2006 034 584) tips. Recently, spherical tips in particular have been preferred. The purpose of the spherical shape was to provide the best possible friction radius and thus achieve intense heating of the workpiece.

Prior art self-drilling fastening elements conventionally have a relatively small radius at the tip, in such a way that the tip is spherical in form. This small, spherical contact surface heats the material. An extending, conical hole-forming part having a relatively sharp angle is attached to this tip.

It has been found that prior art tips have to be pressed with a particular force so as to generate sufficient friction, at a sufficiently high rotational speed, for the material to start flowing. Further, prior art tips do not provide optimum tube formation.

### DESCRIPTION OF THE INVENTION

Starting from this prior art, the object of the present invention is therefore to provide a drilling tip for a self-drilling fastening element which minimises the shaping time and simultaneously improves the performance of the connection, in particular by way of optimum tube formation. According to the invention, the self-drilling fastening elements should be manufactured as economically as possible, even in the case of high sheet metal thicknesses or when they are to be placed in two unholed metal sheets which are positioned one on top of the other (in particular in the case of self-drilling blind rivets).

According to the invention, this object is achieved in that the cross-section of the drilling tip is bounded by a first radius close to the tip and a second radius close to the shank, the origin of the second radius being further than the origin of the first radius from the axis of rotation.

It is particularly preferred for the two radii to transition tangentially into one another.

Further, it is particularly preferred for the second radius to transition into the shank via a conically extending portion. This conically extending portion makes optimum tube formation possible.

In this case, the conical portion preferably has an angle α of 28° to 40°, preferably 32°, between the flanks thereof.

Further, in this case it is particularly preferred for the second radius to transition into the shank via a concavely curved portion having a radius of which the center point is positioned on the same side of the axis of rotation.

This improves the tube formation even more.

Further, it has been found to be highly advantageous for at least the portion between the second radius and the shank to be provided with grooves which circulate radially perpendicular to the axis of rotation.

In this case the grooves preferably have a semi-circular cross-section.

### BRIEF DESCRIPTION OF THE DRAWINGS

The invention is explained in greater detail in the following by way of the appended drawings, in which:

FIG. 1 is a side view of a self-drilling screw having a drilling tip according to the invention;

FIG. 2 is the section A-A from FIG. 1;

FIG. 3 is the detail of the tip from FIG. 2;

FIG. 4 is a side view of a self-drilling screw having a further drilling tip according to the invention having encircling grooves;

FIG. 5 is a side view of a self-drilling screw having yet another drilling tip according to the invention having a concavely curved portion; and

FIG. 6 is a side view of a self-drilling screw having a further drilling tip according to the invention having a concavely curved portion and radially encircling grooves.

### PREFERRED EMBODIMENT OF THE INVENTION

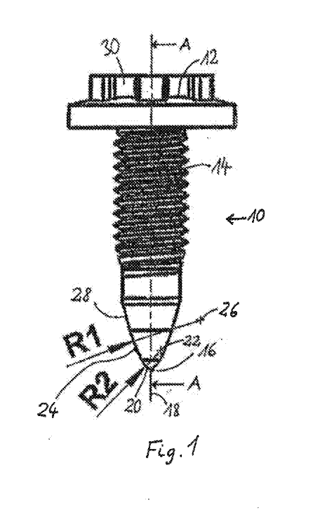

FIG. 1 shows a self-drilling screw according to the invention, which is adapted for flowing hole drilling. The screw 10 consists of a head 12 and a shank 14, which is provided with a self-cutting external thread and ends in a tip 16.

The screw 10 is formed with rotational symmetry about an axis of rotation 18.

The tip 16 comprises a first region 20, in which the section along the axis A-A through the tip 16 has an outer contour which follows a radius R2, the center point of which is positioned laterally outside the axis of rotation 18 on the opposite side of the axis of rotation 18.

This region 20, in which the cross-section of the tip 16 is bounded by the radius R2, is adjoined towards the shank 14 by a further region 24, in which the cross-section of the tip 16 is externally bounded by a further, larger radius R1, having an origin 26 which is also positioned on the opposite side of the axis of rotation 18 but is much further away from the axis of rotation.

This second region of the tip 16 is adjoined towards the shank 14 by a conical portion 28, which subsequently transitions with a slight radius into the shank 14.

In this case, the conical portion 28 of the tip 16 has an angle of 28-40°, preferably 32′, between the lines externally bounding the cross-section thereof.

In the embodiment shown, the screw head 12 has a hexalobular external driving feature 30. Naturally, any other conventional driving features may similarly be used.

A tip configured according to the invention can equally be used for self-drilling blind rivets which use flowing hole drilling and for any other self-drilling fastening elements.

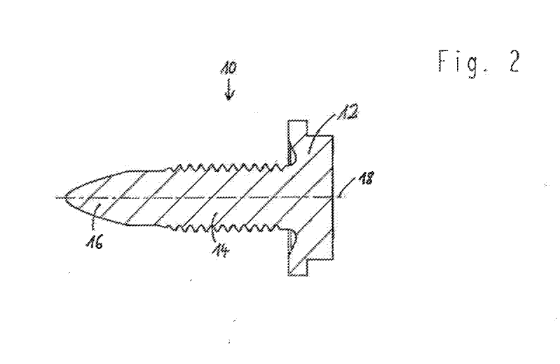

FIG. 2 is a sectional view along the section line A-A (the axis of rotation 18).

In this case an M5 screw is selected as an example of the dimensioning.

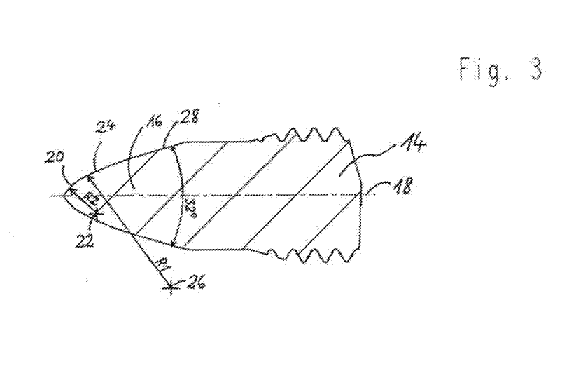

The tip 16 thereof is shown in detail in FIG. 3.

FIG. 3 clearly shows that the outer contour of the tip 16, shown in section in this figure, actually has a proper point rather than a spherical shape at the end remote from the shank. This point results from the meeting of the two radii R2, the origin of which is positioned outside the axis of rotation 18 on the respectively opposite side.

The following is an example of the dimensioning for an M5 screw:

The first radius R2 is 1.5 mm and the origin 22 thereof is 1.3 mm away from the tip towards the shank 14 and 0.7 mm away from the axis of rotation 18. The adjoining radius R1 is 10.8 mm and the origin thereof is 5.7 mm away from the tip and 8.9 mm away from the axis of rotation. This radius subsequently transitions into a conical portion 28, the flanks of which form an angle of 32°.

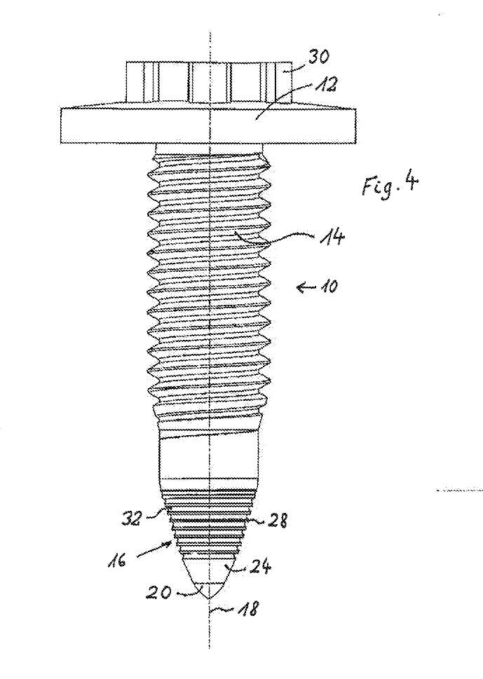

FIG. 4 shows a further embodiment according to the invention of a self-drilling screw.

The head and shank correspond to the screw according to FIG. 1, and the drilling tip is also provided with the two radii R1 and R2 and the conical portion 28.

However, the entire conical portion 28 and part of the portion curved with radius R1 are provided with radially extending grooves 32 arranged horizontally with respect to the axis of rotation 18. These grooves have a semi-circular cross-section.

One the one hand, the grooves 32 further improve the tube formation and reduce the material bank on the penetration side of the self-drilling screw, and further, the increased friction means that even if the screw has a low rotational speed during drilling, sufficient heat energy is available to plasticise the workpiece material.

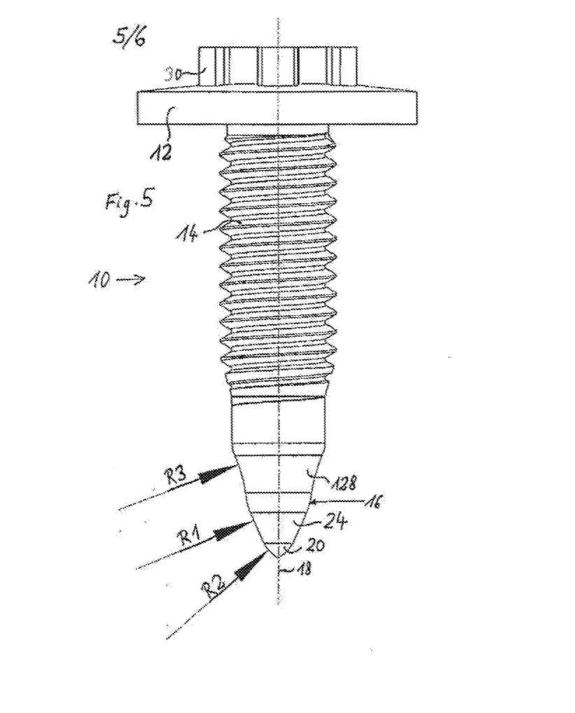

FIG. 5 shows a further embodiment according to the invention of the self-drilling screw. In this case too, the screw head 12 and the screw shank 14 are formed as in FIG. 1.

However, the drilling tip is modified in such a way that instead of the conical portion 28, a concavely curved portion 128 is arranged between the shank 14 and the second radius R1. This concave configuration means that the tube formation is further optimised and, most importantly, prevents plasticised material from being thrown up counter to the penetration direction of the self-drilling screw. Because according to the invention barely any material is thrown up on the penetration side of the screw, more material is available for the tube formation, and the screw can also be placed in correspondingly thinner material.

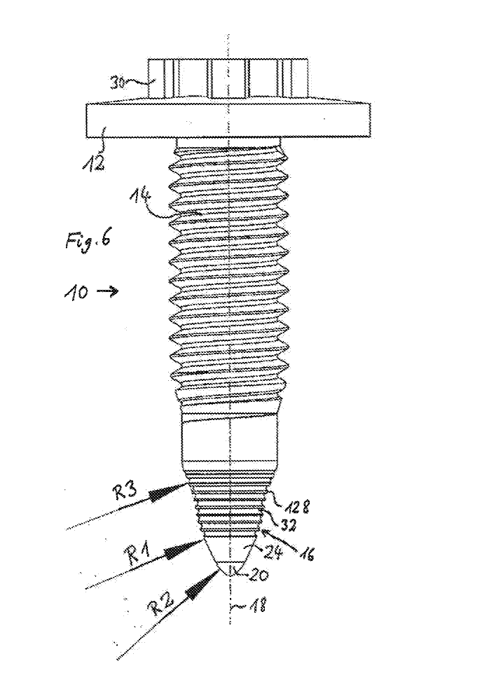

Finally, FIG. 6 shows a combination according to the invention of the features of FIGS. 4 and 5, a concavely curved portion 128, having a radius R3 of which the center point is positioned on the same side of the axis of rotation, being provided between the second radius R1 and the shank 14, and this portion 128 and part of the region of the second radius R1 being provided with radially extending grooves 32, which are arranged horizontally with respect to the axis of rotation 18 and have a semi-circular cross-section.

This combination of features according to the invention provides a minimum material bank on the penetration side as well as optimum tube formation and high plasticisation even at relatively low rotational speeds, by way of the increased friction due to the grooves 32.

The embodiment according to the invention has the major advantage that this new shape of the tip or cap minimizes the shaping time and improves the force transfer through the connection. In this way, a fastening element according to the invention can be placed even in thick metal sheets or in two unholed metal sheets which are positioned one on top of the other much more economically. This is of particular relevance for use with self-drilling blind rivets.

The configuration according to the invention of the tip 16 provides rapid shaping into thick metal sheets and rapid heating on the point where the fastening element is placed. Offsetting the origins of the shaping radii R1, R2 from the axis of rotation 18 of the fastening element 10 provides an absolute point. The adjoining frictional cone, formed by the radii R2 and R1 and by the conical portion 28, optimizes the tube formation. This is particularly relevant for self-drilling screws.

By comparison with the prior art, the present invention also has the advantage that particularly rapid formation is provided even at high material thicknesses of the workpiece in which the fastening element 10 is placed. The frictional cone 28, in connection with the two portions 20 and 24, thus provides good heating and particularly pronounced tube formation on the underside of the metal sheet.

This frictional cone which is specially configured according to the invention promotes the tube formation. This results in a larger number of supporting thread turns on the counter support when the present invention is applied to a screw.

According to the prior art, a relatively small radius was provided at the tip. This small, spherical contact surface was used to heat the material of the workpiece in which the fastening element was to be placed.

According to the invention, the material of the workpiece is heated not by the tip formation, but instead by the following radii R2, R1 which are offset from the centre, transition tangentially into one another, and have an adjoining conical shaped part 28. In the specific combination thereof according to the invention, this shaping provides a large contact surface, correspondingly rapid heating of the material, and good tube formation.

Thus, according to the invention the shaping time is reduced and at the same time the number of supporting thread turns is increased. The present invention can therefore be used even with very high sheet metal thicknesses and two or more unholed metal sheets.

1. Self-drilling fastening element (10) comprising a rotationally symmetrical drilling tip (16) and a shank (14), characterised in that the cross-section of the drilling tip (16) is bounded by a first radius (R2), the origin (22) of which is positioned outside the axis of rotation (18) of the tip (16) on the side opposite the axis of rotation (18), close to the tip (16) and by a second radius (R1) close to the shank (14), the origin (26) of the second radius (R1) being further than the origin (22) of the first radius (R2) from the axis of rotation (18), and also being positioned on the opposite side of the axis of rotation (18).

2. Self-drilling fastening element (10) according to claim 1, characterised in that the two radii (R2, R1) transition tangentially into one another.

3. Self-drilling fastening element (10) according to claim 1, characterised in that the second radius (R1) transitions into the shank (14) via a conically extending portion (28).

4. Self-drilling fastening element (10) according to claim 3, characterised in that the conical portion (28) has an angle α of 28° to 40°, preferably 32°, between the flanks thereof.

5. Self-drilling fastening element (10) according to claim 1, characterised in that the second radius (R1) transitions into the shank (14) via a concavely curved portion (128) having a radius (R3) of which the center point is positioned on the same side of the axis of rotation (18).

6. Self-drilling fastening element (10) according to claim 3, characterised in that at least the portion (28, 128) between the second radius (R1) and the shank (14) is provided with grooves (32) which circulate radially perpendicular to the axis of rotation (18).

7. Self-drilling fastening element (10) according to claim 6, characterised in that the grooves (32) have a semi-circular cross-section.

8. Self-drilling fastening element (10) according to claim 2, characterised in that the second radius (R1) transitions into the shank (14) via a conically extending portion (28).

9. Self-drilling fastening element (10) according to claim 8, characterised in that the conical portion (28) has an angle α of 28° to 40°, preferably 32°, between the flanks thereof.

10. Self-drilling fastening element (10) according to claim 2, characterised in that the second radius (R1) transitions into the shank (14) via a concavely curved portion (128) having a radius (R3) of which the center point is positioned on the same side of the axis of rotation (18).

11. Self-drilling fastening element (10) according to claim 4, characterised in that at least the portion (28, 128) between the second radius (R1) and the shank (14) is provided with grooves (32) which circulate radially perpendicular to the axis of rotation (18).

12. Self-drilling fastening element (10) according to claim 9, characterised in that at least the portion (28, 128) between the second radius (R1) and the shank (14) is provided with grooves (32) which circulate radially perpendicular to the axis of rotation (18).

13. Self-drilling fastening element (10) according to claim 5, characterised in that at least the portion (28, 128) between the second radius (R1) and the shank (14) is provided with grooves (32) which circulate radially perpendicular to the axis of rotation (18).

14. Self-drilling fastening element (10) according to claim 10, characterised in that at least the portion (28, 128) between the second radius (R1) and the shank (14) is provided with grooves (32) which circulate radially perpendicular to the axis of rotation (18).

15. Self-drilling fastening element (10) according to claim 11, characterised in that the grooves (32) have a semi-circular cross-section.

16. Self-drilling fastening element (10) according to claim 12, characterised in that the grooves (32) have a semi-circular cross-section.

17. Self-drilling fastening element (10) according, to claim 13, characterised in that the grooves (32) have a semi-circular cross-section.

18. Self-drilling fastening element (10) according to claim 14, characterised in that the grooves (32) have a semi-circular cross-section.
